(19) United States
(12) Patent Application Publication
(10) Pub. No.: US 2018/0056755 A1
(43) Pub. Date: Mar. 1, 2018

(54) AIR CONDITIONING DEVICE

(71) Applicant: ZHEJIANG TIANHONG AUTO ACCESSORIES CO., LTD., Taizhou City (CN)

(72) Inventor: TONGCHAI CHEN, TAIZHOU CITY (CN)

(21) Appl. No.: 15/679,121

(22) Filed: Aug. 16, 2017

(30) Foreign Application Priority Data
Aug. 30, 2016 (CN) 201610751579.4

(51) Int. Cl. B60H 1/34

(52) U.S. Cl. CPC B60H 1/3407

(57) ABSTRACT

The present invention relates to an air conditioning device, comprising a baseplate provided with a recess, wherein a panel is provided on the baseplate, the panel and the recess form an independent cavity, one or more fans are provided at one end of the baseplate, each fan having an air outlet in communication with the cavity, and a reasonable number of air vents are provided on the panel, the one or more fans blowing air into the cavity and then the air blowing out of the air vents. In the present invention, air is blown outwards through the air vents provided on the panel that are in communication with the cavity, which allows a uniform and gentle outflow of air and brings a comfortable user experience.

### FIELD OF THE INVENTION

The present invention relates to an air conditioning device.

### BACKGROUND OF THE INVENTION

In some occasions, it is necessary to divert airflow of a fan such that the air is blown out over a wider range. Common air conditioning devices at present have a structure (as shown in FIG. 1) which comprises a baseplate 11, an upper surface of the baseplate 11 being provided with several strip-shaped protrusions 12 arranged in rows and columns, air channels 13 being formed between the strip-shaped protrusions 12, and the air channels 13 serving to guide the airflow. The air blown out by the fan is scattered via the air channels 13, so that the air outflow area is increased. However, the air conditioning device of such a structure has the following defects: on one hand, the air blown out by such a structure is natural air, and cannot achieve the effect of cooling air, especially in summer; and on the other hand, since the air channels 13 are open, the air cannot be fully scattered.

### SUMMARY OF THE INVENTION

An object of the present invention is to provide an air conditioning device which allows a uniform outflow of air and has good performance when in use.

The present invention is achieved by:

an air conditioning device, comprising a baseplate provided with a recess, wherein a panel is provided on the baseplate, the panel and the recess form an independent cavity, one or more fans are provided at one end of the baseplate, each fan having an air outlet in communication with the cavity, and a reasonable number of air vents are provided on the panel, the one or more fans blowing air into the cavity and then the air blowing out of the cavity through the air vents.

In such an air conditioning device described above, the one or more fans are provided on a fan mounting plate, one or more air inlets corresponding to the one or more fans in number are provided on the fan mounting plate, the one or more air inlets are in communication with the cavity formed by the panel and the baseplate, and the air outlet of each fan is provided on the side corresponding to the air inlet of the fan mounting plate.

In such an air conditioning device described above, the fan mounting plate is fixed to the baseplate, and the baseplate and the fan mounting plate are of a plate-like structure after being connected.

In such an air conditioning device described above, the panel is provided with protrusions, and the air vents are provided on a region of the panel without the protrusions.

In such an air conditioning device described above, air vents in communication with the cavity are provided on the protrusion.

In such an air conditioning device described above, transverse ribs or longitudinal ribs or ribs arranged in a staggered manner are provided on the panel, and the air vents are provided on the panel without the ribs.

In such an air conditioning device described above, the air vents are trapezoidal holes with a diameter decreasing from the bottom to the top.

Compared with the prior art, significant advantages of the present invention are as follows:

1) in the present invention, air is blown out through the air vents provided on the panel that are in communication with the cavity, which allows a uniform and gentle outflow of air and brings a comfortable user experience;

2) the air vents provided in the present invention are of a bellmouthed structure with a diameter decreasing from the bottom to the top, and can achieve the effect of blowing cold air, thus having a cooling effect, making people feel much cooler especially in summer;

3) the protrusions or ribs provided in the present invention can ensure that the air vents can blow air properly and present good performance when in use, even if the panel is covered; and

4) the protrusions provided on the panel of the present invention has a massaging effect, which improves the comfortability.

### BRIEF DESCRIPTION OF THE DRAWINGS

FIG. 1 is a schematic diagram according to the prior art;

FIG. 2 is a schematic diagram according to the present invention;

FIG. 3 is a schematic diagram according to the present invention with the panel removed;

FIG. 4 is a partial schematic diagram of the rear of the invention;

FIG. 5 is a simplified partial schematic sectional diagram according to the present invention when a surface of the panel is planar;

FIG. 6 is a simplified partial schematic sectional diagram according to the present invention when the surface of the panel is provided with ribs;

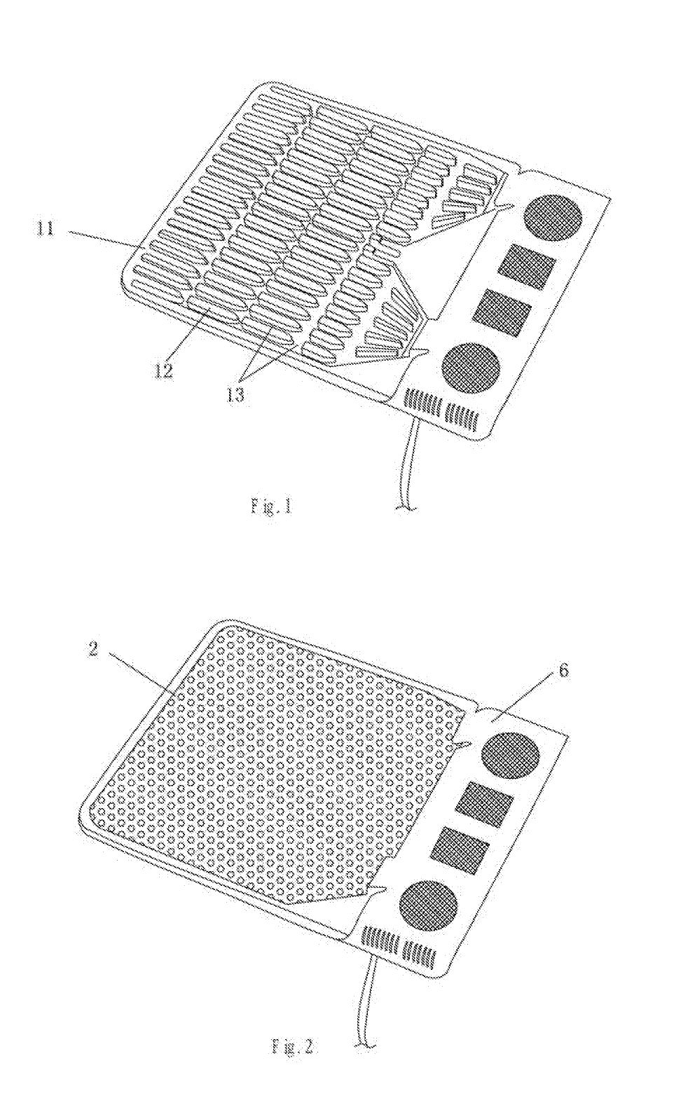

and FIG. 7 is a simplified diagram viewed from the top of the present invention in which the surface of the panel is provided with protrusions and air vents are provided on a region of the panel without the protrusions and on the protrusions.

### DETAILED DESCRIPTION OF THE INVENTION

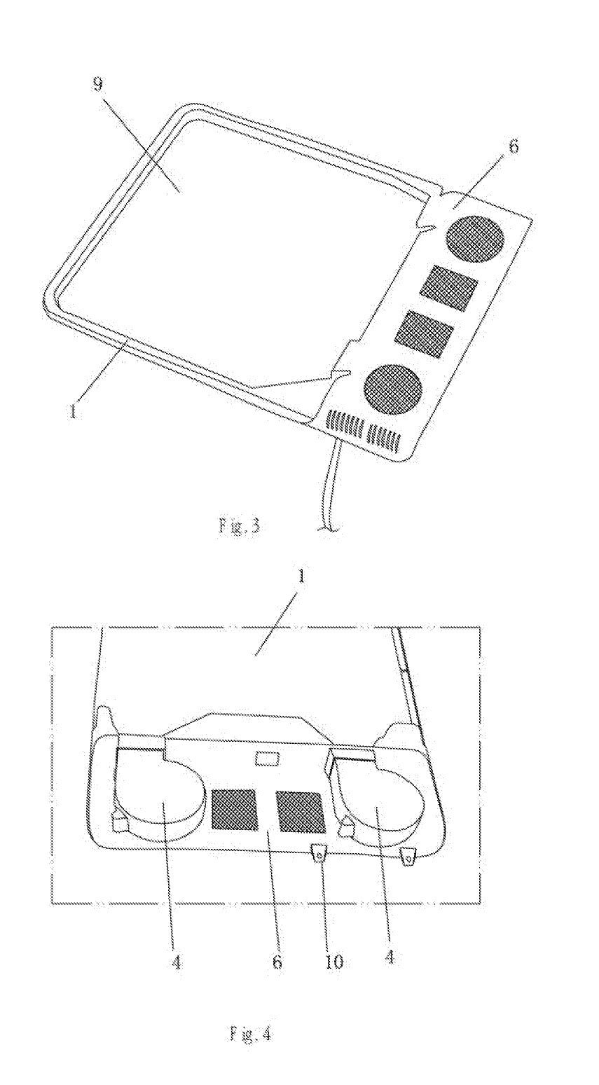

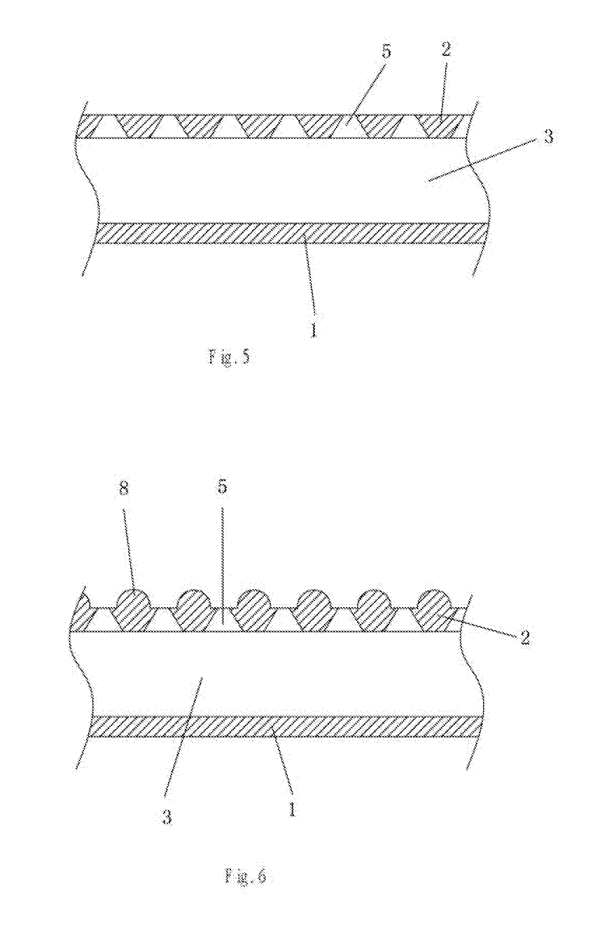

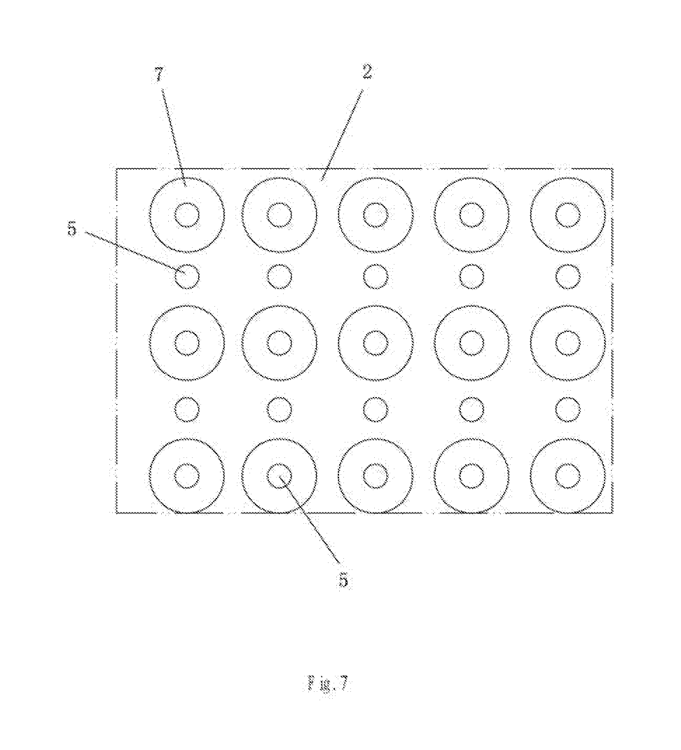

The present invention is further described with particular embodiments below, see FIGS. 2-7.

n air conditioning device comprises a baseplate 1 provided with a recess 8, wherein a panel 2 is provided on the baseplate 1, the panel 2 and the recess 8 form an independent cavity 3, one or more fans 4 are provided at one end of the baseplate 1, each fan 4 having an air outlet in communication with the cavity 3, and a reasonable number of air vents 5 are provided on the panel 2. In the present embodiment, the air vents 5 are provided on the entire panel 2. The specific number of the air vents 5 is set depending on the actual situation. The number of the fan(s) 4 is likewise set depending on the actual situation, and two fans 4 are provided in the present embodiment. The fans 4 can be connected to a mains power supply via a plug or be connected to a power supply in an automobile via an automobile plug.

The working principle of the present invention is as follows:

he fans 4 blow air into the cavity 3, and then the air is blown outwards through the air vents 5. An air outflow area is increased, which enables the back of a human body to feel cool air, and thus comfortable.

Specifically, the one or more fans 4 are provided on a fan mounting plate 6, one or more air inlets corresponding to the one or more fans 4 in number are provided on the fan mounting plate 6, the one or more air inlets are in communication with the cavity 3 formed by the panel 2 and the baseplate 1, and the air outlet of each fan 4 is provided on the side corresponding to the air inlet of the fan mounting plate 6. The fan mounting plate 6 is generally fixed to one end of the baseplate 1 by means of screws or lockers, etc., and can also be of an integral structure. The fan mounting plate 6 and the baseplate 1 form a plate-like structure after being connected to each other. The fans 4 are mounted to lie under the structure.

The present invention can be used with various waist cushions, back cushions or seat cushions.

To facilitate mounting, a mounting portion can be provided on the baseplate 1 or on the fan mounting plate 6, and it is also possible, for example, to fix the device via an elastic belt on an air bag of an air bag waist cushion.

Since the fans 4 heat up in operation, in order to improve the heat dissipation effect, heat dissipation holes are provided on the fan mounting plate 6.

In order to prevent the air vents 5 from being covered and unable to blow air, protrusions 7 are provided on the panel 2. The air vents 5 are provided on a region of the panel 2 without the protrusions 7 so as to achieve the purpose of ventilation. The number of the protrusions 7 is set depending on the actual situation. The protrusions 7 are typically in the form of a truncated sphere, and can also be protrusions in other forms. In addition, the protrusions 7 also have some massaging effect.

Of course, air vents 5 can also be provided on the protrusions 7.

It is also possible to prevent the air vents 5 from being covered by the fact that transverse ribs or longitudinal ribs or ribs arranged in a staggered manner are provided on the panel 2, and the air vents 5 are provided on a region of the panel 2 without the ribs 8. The ventilation is realized by means of the ribs 8.

In the present invention, the air vents 5 are configured as trapezoidal holes with a diameter decreasing from the bottom to the top. The fans force a sufficient amount of air to first enter one end with a large diameter and then exit from the other end with a small diameter, so that a change in air pressure is generated, thereby making the air become cool, and bringing a cooling effect and a more comfortable user experience. The air vents 5 can be arranged regularly or irregularly.

The above-mentioned embodiment is only one of preferable embodiments of the present invention, and is not intended to limit the scope of implementation of the present invention; therefore, any equivalent change made in the shape, structure and principle according to the present invention is to be encompassed within the scope of protection of the present invention.

1. An air conditioning device, characterized by comprising a baseplate provided with a recess, wherein a panel is provided on the baseplate, the panel and the recess form an independent cavity, one or more fans are provided at one end of the baseplate, each fan having an air outlet in communication with the cavity, and a reasonable number of air vents are provided on the panel, the one or more fans blowing air into the cavity and then the air blowing out of the air vents.

2. The air conditioning device according to claim 1, characterized in that the one or more fans are provided on a fan mounting plate, one or more air inlets corresponding to the one or more fans in number are provided on the fan mounting plate, the one or more air inlets are in communication with the cavity, and the air outlet of each fan is provided on the side corresponding to the air inlet of the fan mounting plate.

3. The air conditioning device according to claim 2, characterized in that the fan mounting plate is fixed to the baseplate, and the baseplate and the fan mounting plate are of a plate-like structure after being connected.

4. The air conditioning device according to claim 1, characterized in that the panel is provided with protrusions, and the air vents are provided on a region of the panel without the protrusions.

5. The air conditioning device according to claim 4, characterized in that air vents in communication with the cavity are provided on the protrusions.

6. The air conditioning device according to claim 1, characterized in that transverse ribs or longitudinal ribs or ribs arranged in a staggered manner are provided on the panel, and the air vents are provided on a region of the panel without the ribs.

7. The air conditioning device according to claim 1, characterized in that the air vents are trapezoidal holes with a diameter decreasing from the bottom to the top.
